(19) United States
(12) Patent Application Publication
(10) Pub. No.: US 2004/0032607 A1
(43) Pub. Date: Feb. 19, 2004

(54) Printing apparatus and printing method of the same

(75) Inventors: Osamu Ohkuma, Minato-ku (JP); Nobuyuki Suzuki, Minato-ku (JP); Ryosuke Suzuki, Minato-ku (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/461,347

(22) Filed: Jun. 16, 2003

(30) Foreign Application Priority Data
Aug. 19, 2002 (JP) 2002-238332

(51) Int. Cl. B41F 1/00; G06K 1/00; G06F 15/00

(52) U.S. Cl. 358/1.13; 358/1.18

(57) ABSTRACT

A printer displays selectable printing formats in accordance with attributes of data files acquired from an external device. When one or more data files are specified among the data files stored in a file server, the printer displays color printing and black-and-white printing as a selectable printing format if the color printing is permitted when the specified data file is registered, and the printer displays the black-and-white printing only as the selectable printing format if the color printing is not permitted.

### BACKGROUND OF THE INVENTION

1. Field of the Invention

The present invention relates to a printing apparatus and method for printing data files stored in an external device and a method of the same.

2. Description of the Related Art

Printing services, which receive image files sent from users through the Internet and print the image files received, are available nowadays.

### SUMMARY OF THE INVENTION

The present invention has been made in view of the above circumstances, and provides a printing apparatus and method for displaying a selectable printing format according to the attribute of the data file acquired from the external device.

According to one aspect of the invention, the printer of the invention is a printer that prints data files stored in an external device, which includes a specifying part that allows a user to specify one or more data files among the data files stored, and a display part that displays a selectable printing format according to an attribute of the specified data file when the data file is to be printed.

According to another aspect of the invention, the printing system includes a data file providing device that provides data files, and a printer that prints the data files provided. The data file providing device includes a sending part that sends the provided data files and a format specifying information whereby a user specifies a printing format when the data file is to be printed. The printer possesses a file acquisition part that acquires the sent data files, and a display part that displays the printing format specified by the sent format specifying information.

According to another aspect of the invention, the printing method is a method for printing data files stored in an external device, which includes the steps of specifying one or more data files among data files stored, and displaying a selectable printing format when the data file is printed according to an attribute of the data file specified.

According to another aspect of the invention, a storage medium readable by a computer stores a program of instructions executable by the computer to perform a function for printing data files stored in an external device, and the function includes the steps of specifying at least one data file among data files stored in an external device, and displaying a selectable printing format when the specified data file is to be printed in accordance with an attribute of the specified data file.

### BRIEF DESCRIPTION OF THE DRAWINGS

Preferred embodiments of the present invention will be described in detail based on the followings, wherein:

FIG. 1 illustrates the whole configuration of the printing system;

FIG. 2 illustrates the hardware configuration of a user terminal in FIG. 1;

FIG. 3 illustrates the configuration of the data file accepting program that the file server (shown in FIG. 1) executes;

FIG. 4A illustrates a table in which the database unit (shown in FIG. 3) stores data files in association with passcodes and so forth, and FIG. 4B illustrates a table in which the database unit stores the printing charges in association with the passcodes;

FIG. 5 is a flowchart illustrating the operation (S10) of the printing system while registering a new file;

FIG. 6 illustrates a new-file register screen that the terminal monitor (shown in FIG. 1) displays at S104 in FIG. 5;

FIG. 7 illustrates a register confirmation screen that the terminal monitor (shown in FIG. 1) displays at S118 in FIG. 5;

FIG. 8 illustrates the hardware configuration of the printer (shown in FIG. 1) with the controller placed in the center;

FIG. 9 illustrates the configuration of the printing program that the printer (shown in FIG. 1) executes;

FIG. 10 is a flowchart illustrating the operation (S20) of the printing system while printing a data file;

FIG. 11 illustrates a first operation screen that the UI device (shown in FIG. 8) displays in the processing of S202 in FIG. 10;

FIG. 12 illustrates a second operation screen that the UI device (shown in FIG. 8) displays in the processing of S214 in FIG. 10;

FIG. 13 illustrates a third operation screen (color file) that the UI device (shown in FIG. 8) displays in the processing of S216 in FIG. 10, when the color printing is specified while a data file is registered;

FIG. 14 illustrates a third operation screen (monochrome file) that the UI device (shown in FIG. 8) displays in the processing of S216 in FIG. 10 when the black-and-white printing is specified while a data file is registered;

FIG. 15 illustrates a fourth operation screen that the UI device (shown in FIG. 8) displays in the processing of S220 in FIG. 10; and

FIG. 16A illustrates a table in which the database unit (shown in FIG. 3) stores the shop codes and the upper-limit amount of money when the upper-limit amount differs by shops, in association with the users, and FIG. 16B illustrates a table in which the database unit stores the unit prices of the printing charges when the unit prices are different by shops.

### DETAILED DESCRIPTION OF THE PREFERRED EMBODIMENTS

Many convenience stores and other copying service shops in Japan and in other parts of the world have color copiers installed, and a general user is able to use the color copier by putting coins into a payment-accepting unit of the copier.

The user is able to print data files at different places by use of such a color copier.

For example, the user uploads data files to a file server connected to the Internet and so forth, and registers them.

And, whenever the user wishes to print a data file, the user downloads the data file from the file server, and operates the color copier to print the file.

Such color copiers can perform both color printing and black-and-white printing, and it can print data files in accordance with the user's choice.

However, among the data files downloaded to the color copier, there are some files not containing data that can be color printed. In such a case, the user's wrong choice of the color printing mode will result in black-and-white printing.

Even when printing a data file containing the data that can be color printed, there are some cases that the user wants it in black-and-white.

In consideration of the above circumstances, the printing method of this invention displays selectable printing formats in accordance with the attributes (whether or not the file contains data that can be color printed) of the data files downloaded.

According to the printing method of this invention, the user is able to select a desired printing format from the printing formats conforming to the attributes of the data files.

[Embodiment]

Next, a concrete example will be taken up to explain the configuration and operation of the printing system 1, to which the method of receiving data files of this invention is applied.

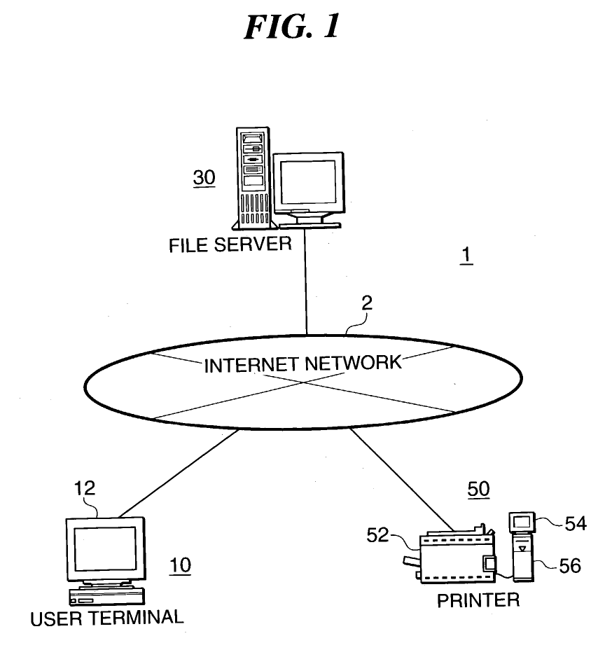

FIG. 1 illustrates the configuration of the printing system 1.

As illustrated in FIG. 1, the printing system 1 includes a user terminal 10 that requests to register data files, a file server 30 (data file providing device) that registers the data files, a printer 50 (printing unit) that prints the registered data files, and an Internet network 2 that connects these devices.

The user terminal 10 is a computer terminal installed in a user's house, for example, which possesses a terminal monitor 12 that displays the register screens of data files and so forth.

The printer 50 is installed in a convenience store or the like, which contains a printing unit 52 that executes the printing processing, a user interface (UI device) 54 that accepts user operations by means of touch panel contacts, for example, and a payment accepting unit 56 that accepts the payment of printing charges of the data files.

[Outline of the Printing System]

Next, the operation of the printing system 1 will be described with reference to FIG. 1.

When a user wishes to print a given data file (image files and text files, etc.) by the printer 50, the user sends the data file to the server 30 from the user terminal 10, and requests the server to register the data file.

Receiving the data file, the file server 30 generates a passcode for identifying the data file, and registers the data file received in association with the generated passcode.

Here, the passcode is the identifying information for uniquely specifying the data file. For example, the passcode assumes the form of a character string (a string of alphabet and numerals) that is generated uniquely for each data file.

The file server 30 causes the terminal monitor 12 to display the generated passcode, and informs the user of the passcode.

When the user wishes to print the registered data file, the user goes to a place where the printer 50 is installed, and inputs the passcode to the UI device 54 of the printer 50.

The printer 50 downloads the data file corresponding to the input passcode from the file server 30, and prints the data file downloaded on the condition of having received the printing charge.

[Details of the Components]

The components of the printing system 1 will be described more in detail.

A concrete example will be shown to explain the configurations of the user terminal 10 and the file server 30 that are operational during registration of the data files.

[User Terminal/File Server]

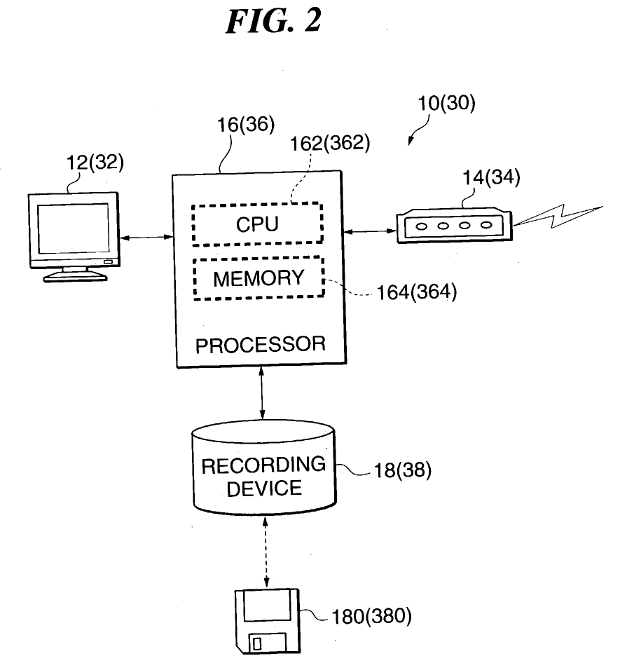

FIG. 2 illustrates the hardware configuration of the user terminal 10 (file server 30) shown in FIG. 1.

As shown in FIG. 2, the user terminal 10 includes the terminal monitor 12 (user interface part) such as an LCD display or a CRT display or the like, a communication device 14 (sending part) that executes data communications in connection with the Internet network 2, a processor 16 such as a CPU 162 and a memory 164, and a storage device 18 such as a HDD/CD drive.

The file server 30 includes a terminal monitor 32, a communication device 34, a processor 36, and a recording device 38 and so forth, in the same manner as the user terminal 10.

The user terminal 10 possesses a browser function that enables browsing of HTML documents and so forth, and displays the register screens and so forth on the terminal monitor 12 in accordance with the instructions from the server 30.

[Data-File Accepting Program 400]

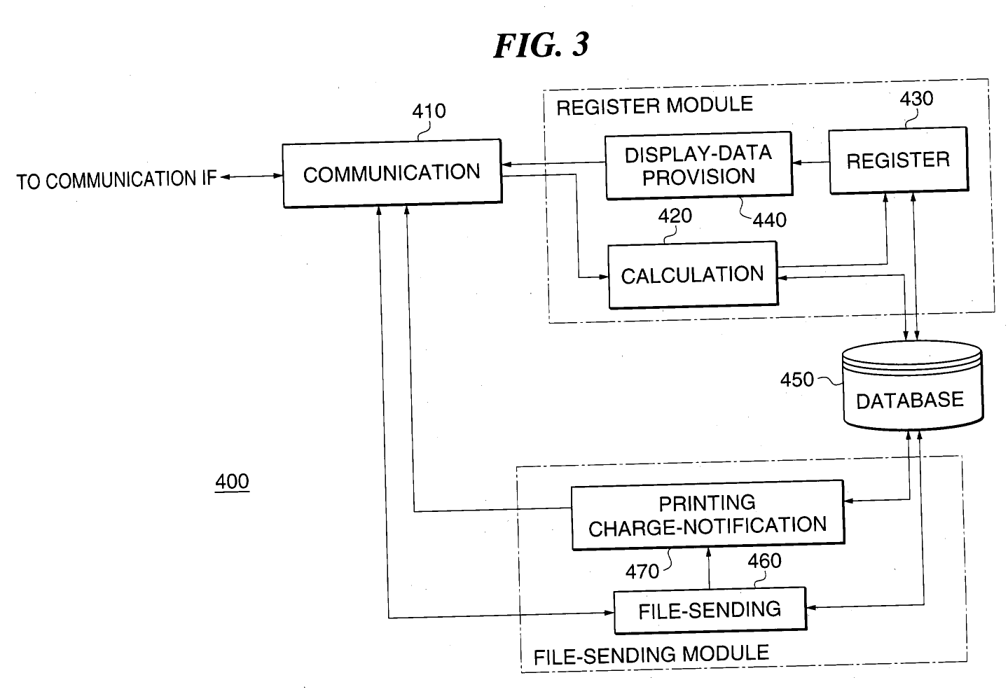

FIG. 3 illustrates the configuration of the data-file accepting program 400 performed by the file server 30.

As shown in FIG. 3, the data-file accepting program 400 includes a communication unit 410 (sending part), a calculation unit 420, a register unit 430, a display-data providing unit 440, a database unit 450, a file-sending unit 460, and a charge-notifying unit 470.

The calculation unit 420, register unit 430, and display-data providing unit 440 mainly function as a registering module that registers data files. The file-sending unit 460 and charge-notifying unit 470 mainly function as a file-sending module that sends data files to the printer 50 (FIG. 1).

The data-file accepting program 400 is provided to the file server 30 through a recording medium 380, for example, and the server executes the program.

In the data-file accepting program 400, the communication unit 410 controls the communication device 34 (FIG. 2) of the file server 30, and executes the sending and receiving of data with the user terminal 10 and the printer 50.

Receiving a newly registered data file from the communication unit 410, the calculation unit 420 calculates the printing charges in accordance with the number of pages, the size of the printing pager, and the printing format (either color printing or black-and-white printing).

The data file is a set of the image data and text data and so forth, which are to be printed. When one data file is printed, the number of pages may be two or more.

The printer 50 of this embodiment charges the printing charges in accordance with the number of pages printed, and thus, the calculation unit 420 calculates the printing charges in accordance with the number of pages in which the data file is printed.

When color printing is specified as the printing format in registering the data file, the printer 50 is able to print the data file either in color or black-and-white.

Accordingly, when color printing is specified as the printing format, the calculation unit 420 calculates the printing charge when the file is printed in color and the printing charge when printed in black-and white, and outputs the printing charges calculated and the data file received to the register unit 430.

When black-and-white printing is specified as the printing format, the calculation unit 420 calculates only the printing charge when printed in black-and-white.

The register unit 430 compares the calculated charges with the preset upper-limit amount. When the calculated charges are equal to or less than the upper-limit amount, the register unit 430 generates a passcode, associates it with the received data file and the calculated charges, and outputs the result to the database unit 450. And, the register unit 430 outputs to the display-data providing unit 440 a message that the received data file is can be registered.

In reverse, when the calculated charges exceed the upper-limit, the register unit 430 outputs to the display-data providing unit 440 a message that the received data file is not registrable.

Here, the upper-limit is preset in accordance with the amount of money that the payment accepting unit 56 will accept.

And, when the data file is registered, the register unit 430 generates a thumbnail data of the data file, and outputs the generated thumbnail data to the database unit 450, in association with the passcode.

Here, the thumbnail data is a reduced image data in which the gradation or definition of the image when the data file is printed is simplified, and the data size thereof is reduced compared to that of the data file itself.

The thumbnail image is used mainly for preview.

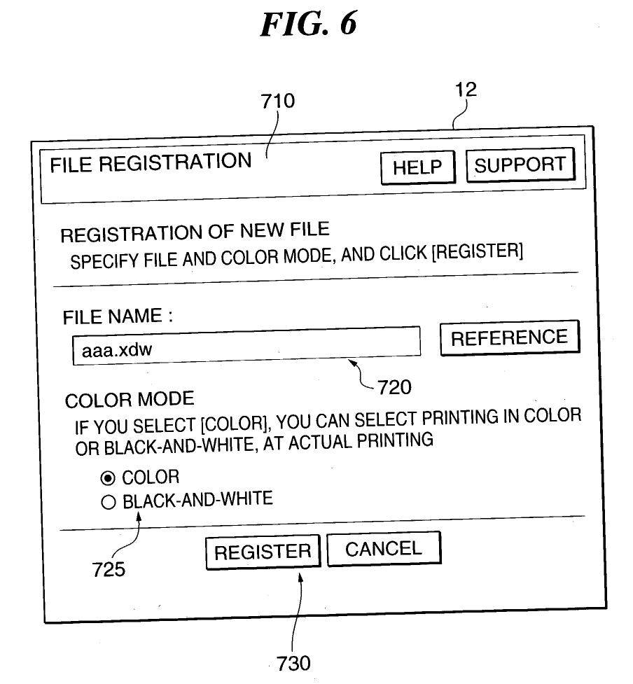

Receiving an access from the user terminal 10 (FIG. 1) to a new-file registering site, the display-data providing unit 440 causes the user terminal 10 to display a new-file register screen (described later with reference to FIG. 6) on the condition that the user registration is completed.

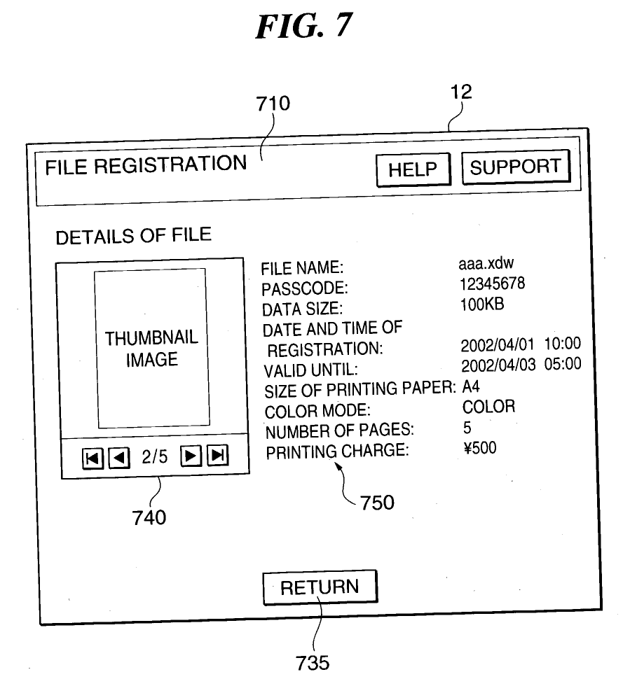

When the register unit 430 determines that the data file is registrable, the display-data providing unit 440 causes the user terminal 10 to display a register confirmation screen (described later with reference to FIG. 7); when the register unit 430 determines otherwise, the display-data providing unit 440 causes the user terminal 10 to display a message that the data file is not registrable.

The database unit 450 stores information input from the register unit 430 and so forth into a recording medium, and searches the information input upon request.

Receiving a passcode from the printer 50 (FIG. 1), the file-sending unit 460 requests the database unit 450 to search the thumbnail data and the data file corresponding to the passcode, and sends the thumbnail data and the data file corresponding to the passcode to the printer 50.

Receiving a passcode from the printer 50 (FIG. 1), the charge-notifying unit 470 requests the database unit 450 to search charge information corresponding to the passcode received, and sends the charge information corresponding to the passcode to the printer 50.

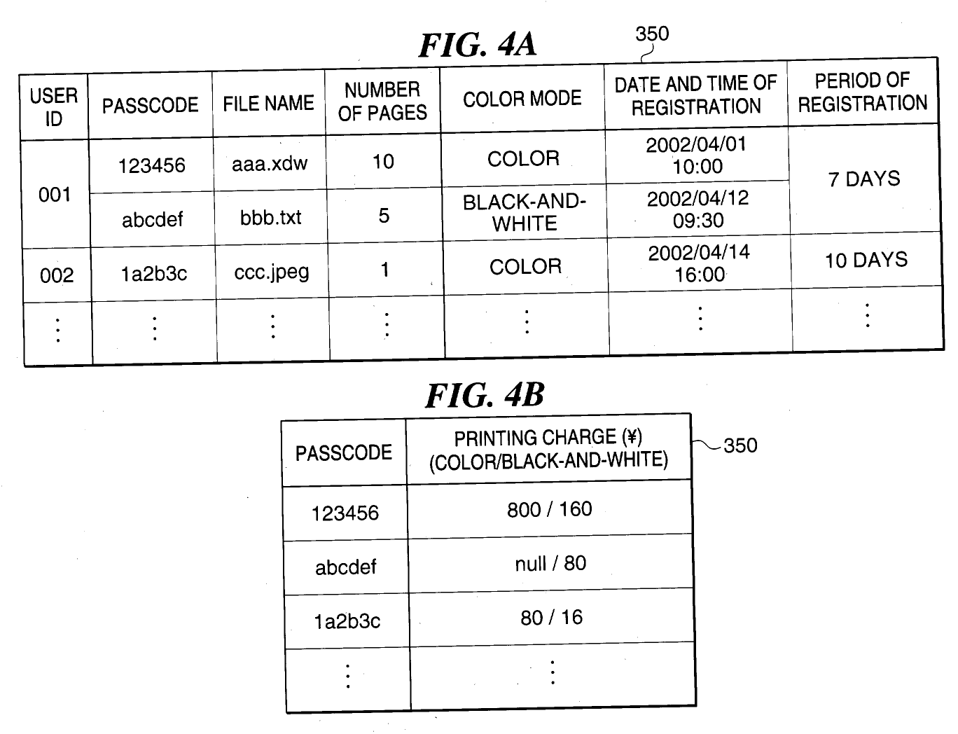

FIG. 4A illustrates a table in which the database unit 450 (FIG. 3) stores data files in association with passcodes and so forth, and FIG. 4B illustrates a table in which the database unit 450 stores the printing charges in association with the passcodes.

As shown in FIG. 4A, the database unit 450 stores the name of the data file registered, the user ID of the user who registered the data file, the number of pages when the data file is printed, the printing format (referred to as color mode hereinafter) specified on this registration, the date of registration, and the period of time which the data file is held in the server, in association with the passcode generated upon registration.

The color mode can be specified among color printing and black-and-white printing and so forth, by the user's operation when the data file is registered.

The user specifies color printing as the color mode, when the user wants the file to be printed in color.

When color printing is specified as the color mode, the file server 30 permits the printer 50 to execute color printing; if specified otherwise, the file server 30 inhibits color printing.

The database unit 450 acquires the specified color mode through the communication unit 410 and so forth, and stores it in association with the name of the data file.

Also, the database unit 450 stores the data file and the thumbnail data of this data file in association with the name of the data file.

Further, the database unit 450 controls the period of time to hold the file in the server, and deletes the data file whose registration period has expired.

As shown in FIG. 4B, the database unit 450 (FIG. 3) stores the charges calculated by the calculation unit 420 in association with the passcode.

When the calculation unit 420 has calculated the charge for color printing and the charge for black-and-white printing, the database unit 450 stores both of the charges calculated; and when the calculation unit 420 has calculated only the charge for black-and-white printing, the database unit 450 stores only the charge for the black-and-white printing, and sets a null value to the column for the charges for the color printing.

[Operation during Registration]

The operation of the printing system 1 during registration of a new file will be described.

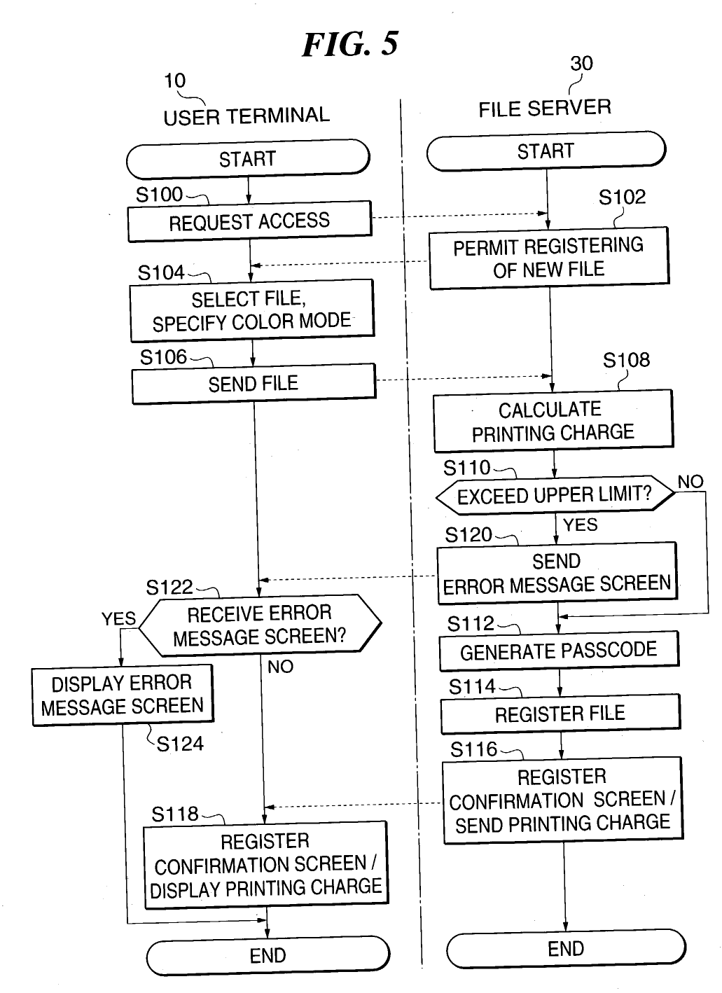

FIG. 5 is a flowchart illustrating the operation (S10) of the printing system 1 during registration of a new file.

As shown in FIG. 5, at step 100 (S100), as the user starts the browser on the user terminal 10 (FIG. 1) and requests an access to the new-file register screen, the user terminal 10 sends the user ID to the file server 30.

At step 102 (S102), receiving the user ID through the communication unit 410 (FIG. 3), the display-data providing unit 440 (FIG. 3) of the file server 30 sends an HTML file for displaying the new-file register screen (described later with reference to FIG. 6) to the user terminal 10 (FIG. 1) on the condition that the user ID is already registered.

At step 104 (S104), as the user specifies a data file to be registered and the color mode for this data file on the new-file register screen, the user terminal 10 (FIG. 1) accepts the designations of the data file and the color mode.

At step 106 (S106), the user terminal 10 sends the identifying information for the specified data file and the specified color mode to the file server 30 (FIG. 1).

At step 108 (S108), as the communication unit 410 (FIG. 3) of the file server 30 receives the identifying information for the data file and the color mode from the user terminal 10 (FIG. 1), the calculation unit 420 (FIG. 3) calculates the printing charges according to the color mode for each data file, and outputs the result to the register unit 430 (FIG. 3).

At step 110 (S110), the register unit 430 (FIG. 3) compares the upper-limit with the calculated printing charge.

The data-file accepting program 400 (FIG. 3) of the file server 30 advances to the processing at S112 if the printing charge is equal to or lower than the upper-limit amount of money; and if it exceeds the upper limit, the program 400 advances to the processing at S120.

At step 112 (S112), the register unit 430 (FIG. 3) generates the passcode corresponding to the data file received.

At step 114 (S114), the register unit 430 sets a mutual association between the user ID, received data file, generated passcode, specified color mode, and calculated printing charge for registration, and outputs the result to the database unit 450.

The register unit 430 generates the thumbnail data of the registered data file, and outputs the thumbnail data, passcode, color mode, printing charges, and so forth to the display-data providing unit 440 (FIG. 3).

At step 116 (S116), the display-data providing unit 440 (FIG. 3) sends the HTML file of the register confirmation screen (described later with reference to FIG. 7) for confirming the thumbnail data, passcode, color mode, printing charges, and so forth to the user terminal 10 (FIG. 1).

At step 118 (S118), according to the received HTML file, the user terminal 10 (FIG. 1) displays the register confirmation screen on the terminal monitor 12 (FIG. 1), which shows the thumbnail image of the registered data file and the passcode, color mode, printing charges, and so forth, and the registering process is completed.

At step 120 (S120), the display-data providing unit 440 (FIG. 3) sends the HTML file containing an error message showing that the data file is cannot be registered to the user terminal 10 (FIG. 1).

At step 122 (S122), if the user terminal 10 (FIG. 1) receives the HTML file of an error image from the file server 30 (Yes at S122), at step 124 (S124), the user terminal 10 displays on the terminal monitor 12 the error image showing that the data file is not registrable, and the process is completed.

[Register Screen]

FIG. 6 illustrates the new-file register screen that the terminal monitor 12 (FIG. 1, FIG. 2) displays at S104 in FIG. 5.

As shown in FIG. 6, the new-file register screen displayed on the terminal monitor 12 possesses a status display area 710 displaying the service that the file server provides, a file specifying area 720 for specifying the data file to be registered into the file server 30, a color mode selection area 725 for selecting the color mode, and a register area 730 for accepting a register instruction of the data file.

The status display area 710 is located on the uppermost part of the screen, which includes an area for displaying the service contents currently provided, which is displayed as ‘file registration’, a clickable area for displaying the Help screen to assist user's input operations and so forth, which is displayed as ‘Help’, and a clickable area for displaying the screen to prepare a mail to be sent to the support center, which is displayed as ‘Support’.

Here, the clickable area is a displayed area that accepts click operations by a user on the terminal monitor 12; and when the clickable area is clicked, the user terminal 10 executes the process to be associated with the clickable area.

The file specifying area 720 is located beneath the status display area 710, which displays a message to prompt the user to operate, and an input form that accepts the data file to be specified for registration.

The file specifying area 720 displays, for example, a message saying that ‘Specify the file and color mode, and click [Register]’, and accepts the input operation of the file name through the input form.

The color mode selection area 725 is located beneath the file specifying area 720, which displays a message of attentions for selecting the color mode, and radio buttons to accept the selection of the color mode.

The color mode selection area 725 displays, for example, a message saying that ‘if you select [Color], you can select printing in color or printing in black-and-white when you need the print, and accepts a selection of the color printing or the black-and-white printing through the radio buttons.

The register area 730 is located on the lowest part of the screen, which displays a clickable area for accepting the operation to instruct the registration of the data file, which is displayed as [Register], and a clickable area for accepting the operation to cancel the registration of the data file, which is displayed as [Cancel].

FIG. 7 illustrates the register confirmation screen that the terminal monitor 12 (FIG. 1, FIG. 2) displays at S118 in FIG. 5.

As shown in FIG. 7, the register confirmation screen displayed on the terminal monitor 12 possesses the status display area 710, a screen shift area 735 to accept a shifting operation of the register screen, a preview display area 740 to display a thumbnail image of the data file being registered, and a registered information display area 750 to display the passcode of the registered data file and so forth.

The status display area 710 and the screen shift area 735 are located on the same positions as those illustrated in FIG. 6.

The status display area 710 is virtually the same as what is shown in FIG. 6.

The screen shift area 735 displays a clickable area to accept the operation to return the current to the previous screen, which is displayed as [Return].

The preview display area 740 is located on the left side of the area between the status display area 710 and the screen shift area 735, which displays the thumbnail image of the registered data file, and a clickable area to accept a page designation for displaying the thumbnail image (the area where the black triangles are arrayed).

The preview display area 740 displays the thumbnail image of the registered data file.

The thumbnail image is displayed for each printed page, on the format whereby the data file is printed.

When the thumbnail image has two or more pages, the preview display area 740 displays the thumbnail images of the different pages, according to a clicking to demand the page shifting.

The registered information display area 750 is located on the right side of the preview display area 740, which displays the file name of the registered data file, passcode, data size, date of registration, period of validity, size of printing paper, color mode, number of pages (same as the number of pages of the thumbnail), and printing charges.

As described above, the user registers a data file to the file server 30 (FIG. 1) by means of the user terminal 10 (FIG. 1).

The scene will now be described, where the registered data file is printed by means of the printer 50 (FIG. 1).

The data file registered in the file server 30 (FIG. 1) is downloaded to the printer 50 (FIG. 1), whereby it is printed.

The file server 30 in the scene where the data file is printed is virtually the same as what has been described with reference to FIG. 1, FIG. 2, and FIG. 3.

[Printer 50]

The configuration of the printer 50 will be described more in detail with a concrete example.

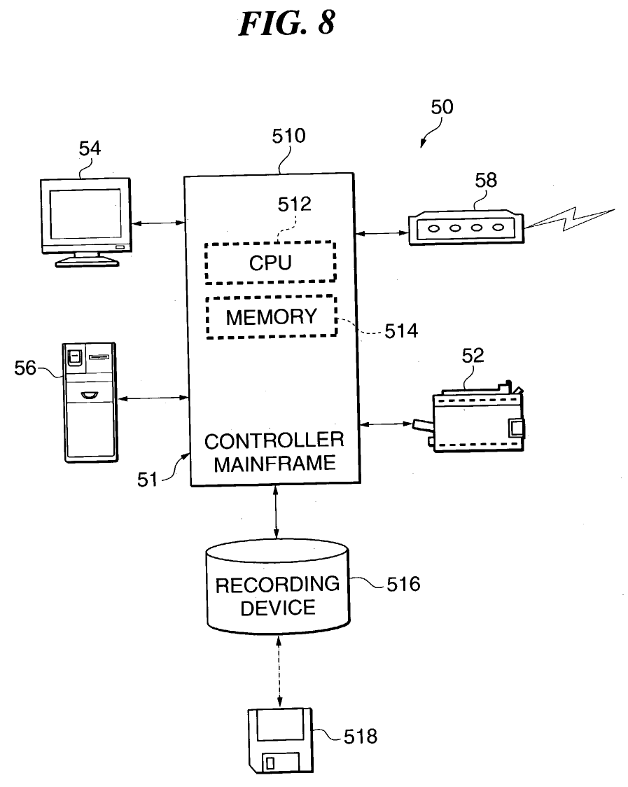

FIG. 8 illustrates the hardware configuration of the printer 50 (FIG. 1) with a controller 51 placed in the center.

As shown in FIG. 8, the printer 50 includes a controller 51, a printing unit 52, an user interface (UI device) 54, a payment accepting unit 56, and a communication device 58.

The controller 51 includes a controller mainframe 510 including a CPU 512 and a memory 514 and so forth, and a recording device 516 including a HDD/CD drive and so forth.

The printing unit 52 forms images by xerographic process.

The UI device 54 includes an LCD display or a CRT display, a keyboard, and a touch panel, etc.

The payment accepting unit 56 accepts coins being put in, and detects the amount of money having been put in.

The communication device 58 exchanges data with the file server 30 through the Internet network 2.

[Printing Program 600]

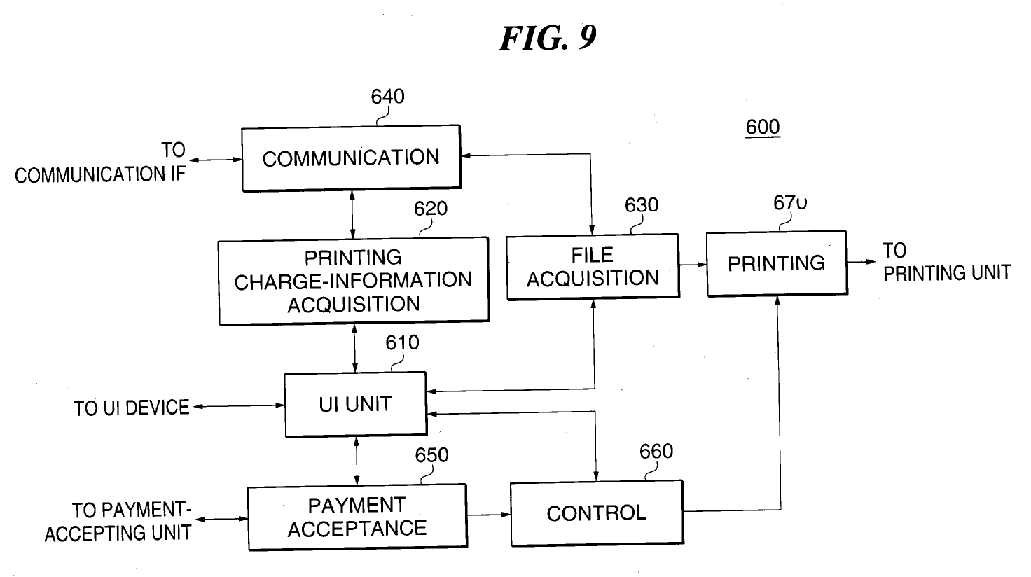

FIG. 9 illustrates the configuration of a printing program 600 executed by the printer 50.

As shown in FIG. 9, the printing program 600 includes a UI unit 610 (designation part, display part), a charge-information acquisition unit 620 (charge-information acquisition part), a file acquisition unit 630 (file acquisition part), a communication unit 640, a payment-accepting unit 650, a control unit 660, and a printing unit 670.

The printing program 600 is supplied to the printer 50 through the recording medium 518 (FIG. 8), for example, and the printer executes the program.

In the printing program 600, the UI unit 610 controls the UI device 54 (FIG. 8), and displays the operation screens and so forth.

And, the UI unit 610 accepts operations to input the passcode and so forth, and outputs them to the charge-information acquisition unit 620 and the file acquisition unit 630 and so forth.

Receiving the passcode from the UI unit 610, the charge-information acquisition unit 620 requests the charge information corresponding to the passcode to the file server 30 (FIG. 1) through the communication unit 640.

Receiving the charge information from the file server 30 through the communication unit 640, the charge-information acquisition unit 620 causes the UI unit 610 to display the printing charges corresponding to the received charge information.

Receiving the passcode from the UI unit 610, the file acquisition unit 630 requests the data file and the thumbnail data corresponding to the passcode to the file server 30 (FIG. 1) through the communication unit 640.

Receiving the data file and the thumbnail data from the file server 30 through the communication unit 640, the file acquisition unit 630 outputs the received data file to the printing unit 670, and causes the UI unit 610 to display the thumbnail data received.

The communication unit 640 controls the communication device 58 (FIG. 8) of the printer 50, and executes data communications with the file server 30 (FIG. 1).

The payment-accepting unit 650 controls the payment accepting unit 56 (FIG. 8) to detect the amount of money put in the payment accepting unit 56, and outputs the result to the UI unit 610 and the control unit 660.

The control unit 660 controls the UI unit 610 and the printing unit 670 in accordance with the amount of money input from the payment-accepting unit 650.

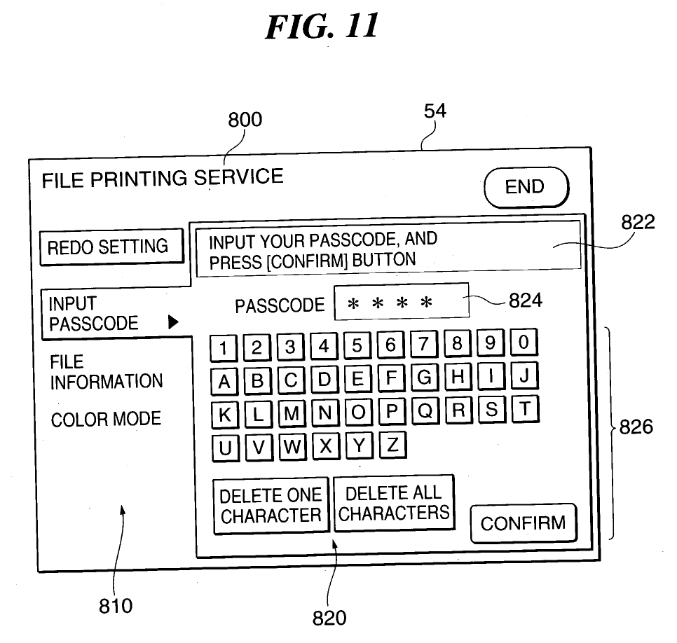

The control unit 660 controls the UI unit 610 to display a first operation screen (described later with reference to FIG. 11) that serves for printing the data file.

The control unit 660 controls the printing unit 670 to start printing the data file, on the condition that the amount of money exceeding the printing charges that the UI unit 610 displays was put in.

The control unit 660 also controls the printing unit 670, when the color mode is specified through the UI unit 610, to print the data file according to the specified color mode (color printing or black-and-white printing).

The printing unit 670 prints the data file input from the file acquisition unit 630 according to the control of the control unit 660.

When the control unit 660 specifies color printing, for example, the printing unit 670 controls the printing unit 52 (FIG. 8) to print the data file in color.

[Operation During Printing]

Next, a description will be made of the operations of the scene where the printer 50 downloads a data file from the file server 30 (FIG. 1) and prints it.

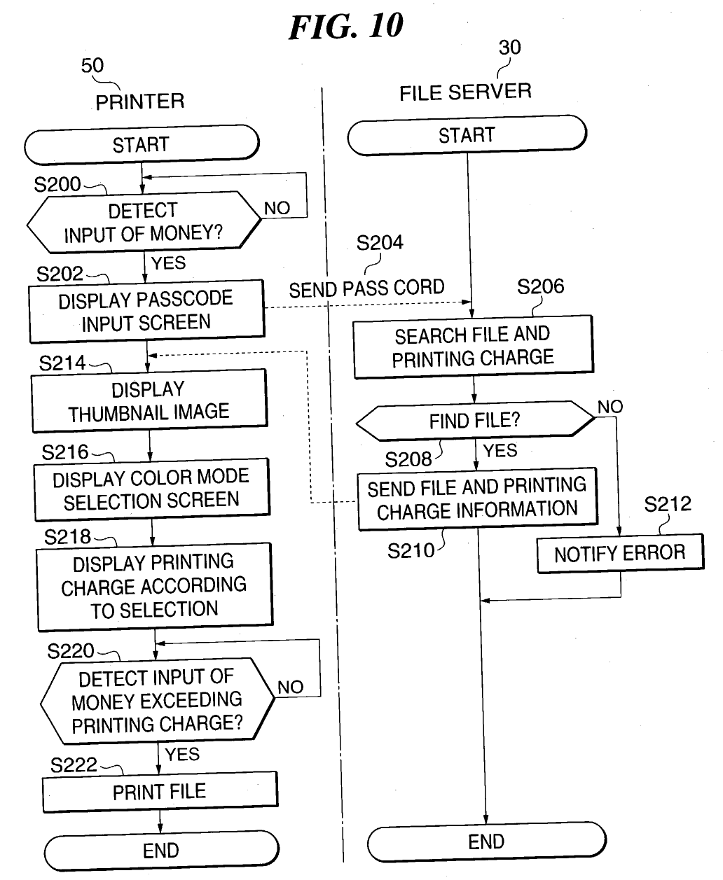

FIG. 10 is a flowchart illustrating the operation (S20) of the printing system 1 while printing a data file.

As shown in FIG. 10, when a user puts in money in the payment accepting unit 56 (FIG. 8) at step 200 (S200), the payment accepting unit 650 (FIG. 9) detects the amount of the money put in.

The printing program 600 (FIG. 9) advances to the processing of S202 if the payment-accepting unit 650 detected the amount of the money; and it waits for the input of money otherwise. At step 202 (S202), the UI unit 610 (FIG. 9) controls the UI device 54 (FIG. 8) to display the first operation screen that serves for inputting the passcode (described later with reference to FIG. 11).

At step 204 (S204), when the user inputs the passcode to the UI device 54 (FIG. 8), the UI unit 610 (FIG. 9) accepts the passcode through the UI device 54, and outputs the received passcode to the charge-information acquisition unit 620 (FIG. 9) and the file acquisition unit 630 (FIG. 9).

The charge-information acquisition unit 620 and the file acquisition unit 630 send the passcode to the file server 30 through the communication unit 640 (FIG. 9), and each request the charge information and the data file corresponding to the input passcode, and so forth.

At step 206 (S206), the file-sending unit 460 (FIG. 3) of the file server 30 requests the database unit 450 (FIG. 3) to search the data file and the thumbnail data corresponding to the received passcode, and the charge-notifying unit 470 (FIG. 3) requests the database unit 450 to search the charge information corresponding to the received passcode.

At step 208 (S208), the database unit 450 (FIG. 3) searches the data file, the thumbnail data, and the charge information corresponding to the passcode.

The data-file accepting program 400 (FIG. 3) advances to the processing of S210 if the database unit 450 finds the data file, the thumbnail data, and the charge information, and otherwise advances to the processing of S212.

At step 210 (S210), first the file-sending unit 460 (FIG. 3) sends the thumbnail data that the database unit 450 found to the printer 50 (FIG. 8) through the communication unit 410 (FIG. 3); and the charge-notifying unit 470 (FIG. 3) sends the charge information that the database unit 450 found to the printer 50 through the communication unit 410.

Then, the file-sending unit 460 starts sending the data file that the database unit 450 found to the printer 50.

At step 212 (S212), the data-file accepting program 400 (FIG. 3) sends to the printer 50 (FIG. 8) a message that the data file, the thumbnail data, and the charge information corresponding to the passcode cannot be found, and completes the processing.

At step 214 (S214), the file acquisition unit 630 (FIG. 9) acquires the data file and the thumbnail data that are sent from the file server 30 (FIG. 1) through the communication unit 640 (FIG. 9), and similarly the charge-information acquisition unit 620 (FIG. 9) acquires the charge information sent from the file server 30.

The file acquisition unit 630 outputs the acquired data file to the printing unit 670 (FIG. 9), and outputs the acquired thumbnail data to the UI unit 610 (FIG. 9).

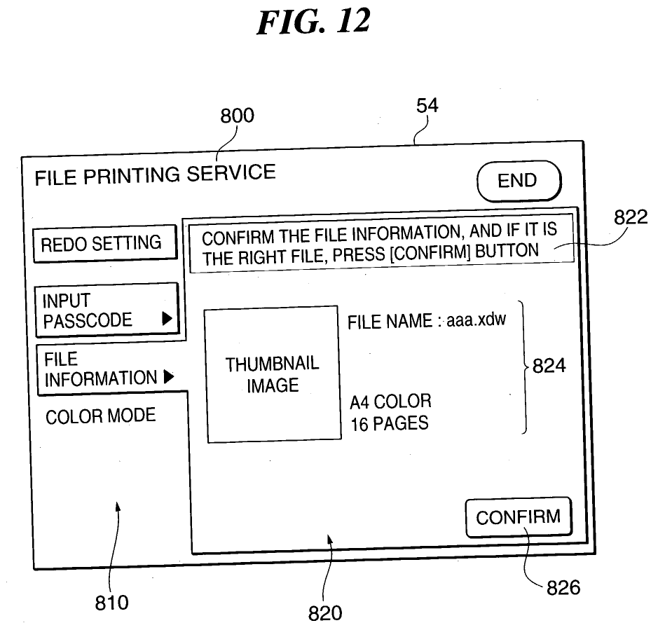

The UI unit 610 controls the UI device 54 (FIG. 8) to display a second operation screen (described later with reference to FIG. 12) including the thumbnail image and so forth, on the basis of the thumbnail data input from the file acquisition unit 630.

The user confirms the data file downloaded from the file server 30 by the displayed thumbnail image.

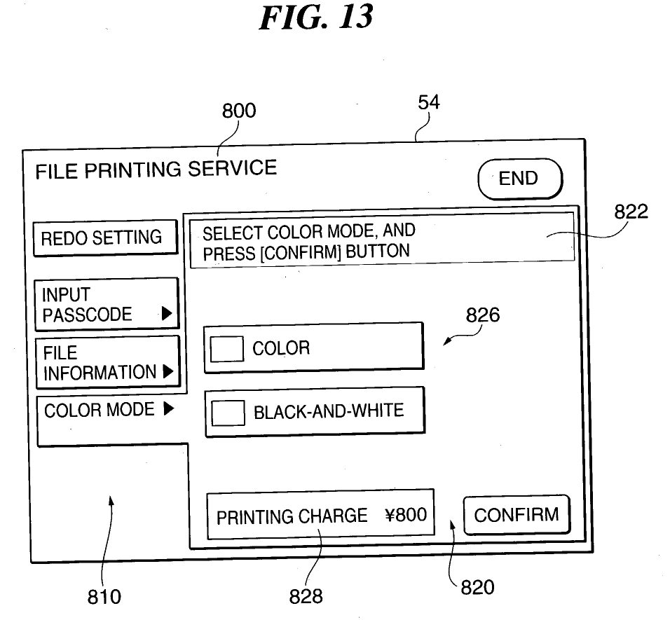

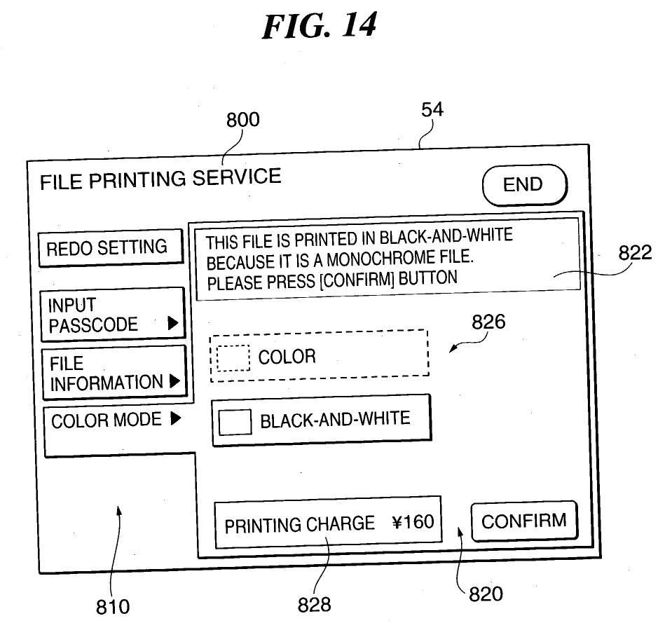

At step 216 (S216), the UI unit 610 (FIG. 9) controls the UI device 54 (FIG. 8) to display a third operation screen (described later with reference to FIG. 13 and FIG. 14) that shows the selectable color mode, and accepts the operation to specify the color mode.

At step 218 (S218), the UI unit 610 (FIG. 9) receives the charge information corresponding to the specified color mode from the charge-information acquisition unit 620 (FIG. 9), and accepts the operation to decide the color mode, by displaying the third operation screen (described later with reference to FIG. 13 and FIG. 14) that shows the printing charges corresponding to the charge information received.

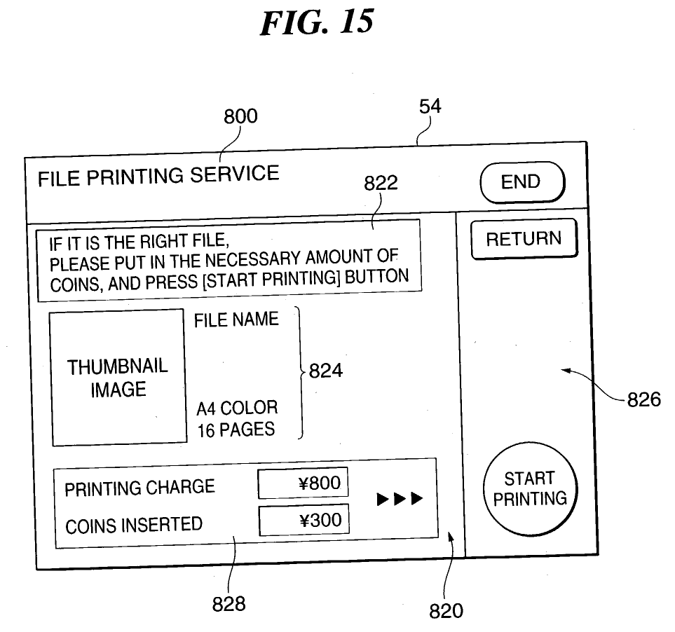

At step 220 (S220), when the user performed the operation to specify the color mode, the UI unit 610 (FIG. 9) displays a fourth operation screen (described later with reference to FIG. 15) that shows the printing charge of the data file and so forth.

And, the payment-accepting unit 650 (FIG. 9) controls the payment accepting unit 56 (FIG. 8) to detect the input amount of money.

The control unit 660 (FIG. 9) controls the UI unit 610 to accept the operation to start the printing, on the condition that the payment-accepting unit 650 detected the amount of money equal to or more than the printing charge.

When the UI unit 610 has accepted the operation to start the printing, the printing program 600 (FIG. 9) advances to the processing of S222, and otherwise, the program waits for the input of money and the operation to start the printing.

At step 222 (S222), the control unit 660 (FIG. 9) instructs the printing unit 670 (FIG. 9) to print the data file; and the printing unit 670 controls the printing unit 52 (FIG. 8), and prints the data file by the specified color mode.

[Operation Screen of Printer]

FIG. 11 illustrates the first operation screen that the UI device 54 (FIG. 8) displays in the processing of S202 in FIG. 10.

As shown in FIG. 11, the first operation screen possesses a status display area 800 displaying the types of services that the printer 50 (FIG. 8) provides, an operation-step display area 810 that displays the steps of input operations by the user, and a user input/output area 820 that displays an operation area according to the operation step.

The status display area 800 is located on the uppermost part of the screen, which includes a part for displaying the service that the printer 50 currently provides, which is displayed as [File Printing Service], and a part for displaying the operation area for accepting the operation to end the file printing service, which is displayed as [End].

Here, the operation area is displayed on the UI device 54 (FIG. 8), which is an area for accepting the operations by the user.

When detecting the operation that the user touches the screen in this operation area, the UI device 54 determines that the data input operation corresponding to this operation area is executed.

For example, detecting the operation that the user touches the screen in the operation area displayed as [End] in the status display area 800, the UI device 54 determines that the instruction to end the processing is executed.

The operation-step display area 810 is located on the left side beneath the status display area 800, which displays the steps of normal input operations in the order from the upper, namely, the step of inputting the passcode (S202 in FIG. 10), the step of confirming the file information (S214 in FIG. 10), and the step of specifying the color mode (S216 in FIG. 10).

The operation-step display area 810 as illustrated in FIG. 11 displays the part displayed as ‘Input Passcode’ in such a manner that the part appears to be integrated with the user input/output area 820, and it displays that the current step is to input the passcode (S202 in FIG. 10).

The operation-step display area 810 further displays the operation area (the part displayed as ‘Redo Setting’) that accepts the operation to initialize the set data (passcode and color mode, etc.).

The user input/output area 820 is located on the right side of the operation-step display area 810, which includes an operation-instruction area 822, a confirmation-display area 824, and an operation area 826.

The operation-instruction area 822 is located on the uppermost part of the user input/output area 820, which displays the message saying that ‘Input your Passcode, and Press [Confirm] button’, and prompts the user to input the passcode.

The confirmation-display area 824 is located below the operation-instruction area 822, which displays that the input is accepted in accordance with the input operation from the user.

The operation area 826 is located on the lower part of the confirmation-display area 824, which displays the operation area that accepts the input of the passcode (the part displayed as the alphanumeric characters), the operation area that accepts the instruction to delete the input passcode (the parts displayed as ‘delete one character’ and ‘delete all characters’), and the operation area that accepts the operation to decide the input passcode (the part displayed as [Confirm]).

FIG. 12 illustrates the second operation screen that the UI device 54 (FIG. 8) displays in the processing of S214 in FIG. 10.

As shown in FIG. 12, the second operation screen possesses the status display area 800, the operation-step display area 810, and the user input/output area 820.

The status display area 800, the operation-step display area 810, and the user input/output area 820 as illustrated in FIG. 12 are located on virtually the same positions as those in FIG. 11.

Further, the status display area 800 as illustrated in FIG. 12 is virtually the same as what is illustrated in FIG. 11.

The operation-step display area 810 displays the part displayed as ‘Input Passcode’ as the operation area that accepts the operation to return to the step of inputting the passcode (the step of S202 in FIG. 10).

The operation-step display area 810 displays the part displayed as ‘File Information’ in such a manner that the part appears to be integrated with the user input/output area 820, and it displays that the current step is to confirm the file information (the step of S214 in FIG. 10).

The user input/output area 820 possesses the operation-instruction area 822, the confirmation-display area 824, and the operation area 826.

The operation-instruction area 822 is located on virtually the same position as that in FIG. 11, which displays the message saying that ‘Confirm the file information, and if it is all right, press [Confirm] button’, and prompts the user to confirm the file information and decide the data file to be printed.

The confirmation-display area 824 is located below the operation-instruction area 822, which displays the thumbnail image of the data file, the file name, the size (A4) of the printing paper, and the number of pages (16 pages) for printing the file.

The operation area 826 is located on the lower right of the confirmation-display area 824, which displays the operation area that accepts the operation to decide the data file to be printed (the part displayed as [Confirm]).

FIG. 13 illustrates the third operation screen (color file) that the UI device 54 (FIG. 8) displays in the processing of S216 in FIG. 10, when the user has specified color printing while registering a data file.

As shown in FIG. 13, the third operation screen (color file) includes the status display area 800, the operation-step display area 810, and the user input/output area 820.

The status display area 800, the operation-step display area 810, and the user input/output area 820 as illustrated in FIG. 13 are located on virtually the same positions as those in FIG. 11.

Further, the status display area 800 as illustrated in FIG. 13 is virtually the same as what is illustrated in FIG. 11.

The operation-step display area 810 displays the part displayed as ‘Input Passcode’ as the operation area that accepts the operation to return to the step of inputting the passcode (the step of S202 in FIG. 10), and it displays the part displayed as ‘File Information’ as the operation area that accepts the operation to return to the step of confirming the file information (the step of S214 in FIG. 10).

The operation-step display area 810 displays the part displayed as ‘Color Mode’ in such a manner that the part appears to be integrated with the user input/output area 820, and it displays that the current step is to specify the color mode (the step of S216 in FIG. 10).

The user input/output area 820 includes the operation-instruction area 822, the operation area 826, and a charge display area 828.

The operation-instruction area 822 is located on virtually the same position as that in FIG. 11, which displays the message saying that ‘Select color mode, and press [Confirm] button’, and prompts the user to specify the color mode and confirm the specified color mode.

The operation area 826 is located below the operation-instruction area 822, which displays the operation area that accepts the operation to select the color mode (the part displayed as [Color] and the part displayed as [Black-and-white]), and the operation area that accepts the operation to decide the operations selected (the part displayed as [Confirm]).

Accepting the operation to select the color mode, the operation area 826 changes the color of the operation area that has accepted the operation, and thereby displays that the color mode corresponding to this operation area is selected.

The charge display area 828 is arranged below the operation area that accepts the operation to select the color mode, which displays the printing charges corresponding to the color mode selected.

FIG. 14 illustrates the third operation screen (monochrome file) that the UI device 54 (FIG. 8) displays in the processing of S216 in FIG. 10, when the user specifies black-and-white printing while registering a data file.

As shown in FIG. 14, the third operation screen (monochrome file) possesses the status display area 800, the operation-step display area 810, and the user input/output area 820.

The status display area 800 and the operation-step display area 810 as illustrated in FIG. 14 are virtually the same as what are illustrated in FIG. 13.

The user input/output area 820 possesses the operation-instruction area 822, the operation area 826, and the charge display area 828.

The operation-instruction area 822 is located on virtually the same position as that in FIG. 13.

The operation-instruction area 822 as illustrated in FIG. 14 is different from what is illustrated in FIG. 13. Since black-and-white printing was specified when the data file was registered, the area 822 does not display the message to prompt the user to specify the color mode, but displays the message saying that ‘Printing is performed in black-and-white because the specified file is monochrome. Please press [Confirm] button’. Thereby, the area 822 informs the user that black-and-white printing is performed, and prompts the user for confirmation.

The operation area 826 is located on the same position as that in FIG. 13, which displays the part displayed as [Color] with a reduced concentration of the color, for example, in order to show the user that the part displayed as [Color] cannot be selected.

The charge display area 828 displays the printing charge for black-and-white printing.

FIG. 15 illustrates the fourth operation screen that the UI device 54 (FIG. 8) displays in the processing of S220 in FIG. 10.

As shown in FIG. 15, the fourth operation screen possesses the status display area 800 and the user input/output area 820.

The status display area 800 as illustrated in FIG. 15 is located on virtually the same position as that in FIG. 11, and the user input/output area 820 is located below the status display area 800.

The status display area 800 as illustrated in FIG. 15 is virtually the same as what is illustrated in FIG. 11.

The user input/output area 820 possesses the operation-instruction area 822, the confirmation-display area 824, the operation area 826, and the charge display area 828.

The operation-instruction area 822 is located on the left of the uppermost part of the user input/output area 820, which displays the message saying that ‘If it is the right file, please put in the necessary amount of coins, and press [Start Printing] button’, and makes the user confirm the thumbnail image, the file name, the size of the printing paper, and the number of pages to be printed, and prompts the user to input the coins and instruct to start the printing.

The confirmation-display area 824 is located below the operation-instruction area 822, which displays the thumbnail image of the data file, the file name, the size (A4) of the printing paper, and the number of pages (16 pages) to be printed.

The operation area 826 is located on the right side of the operation-instruction area 822, the confirmation-display area 824, and the charge display area 828, which displays the operation area that accepts the operation to start the printing (the part displayed as ‘Start Printing’), and the operation area that accepts the operation to return to the step (S216 in FIG. 10) of specifying the color mode (the part displayed as [Return]).

The charge display area 828 displays the charges necessary for the printing (‘Printing Charge’ and ‘¥800’), and the amount of money that the payment-accepting unit 650 (FIG. 7) has detected (‘Coins Inserted’ and ‘¥300’).

The operation area that accepts the operation for the user to instruct starting the printing becomes able to accept the operation when the amount of money input by the user becomes equal to or more than the charges necessary for the printing.

In this manner, the user performs the input operation according to the operation screens, and prints the data file registered to the file server 30 at a place where the printer 50 is installed.

With this system, if a material urgently becomes necessary on the place that the user visits, the printer 50 installed nearby is able to print necessary number of copies of the material for the, and it becomes unnecessary for the user to prepare and carry materials.

[Modified Example]

In some cases, the upper-limit amounts of money which the payment accepting unit 56 (FIG. 1) allows the user to input differ by shops.

In such a case, the register unit 430 (FIG. 3) is required to determine as to whether or not the registering is possible on the basis of the upper-limit amount of money that differ by shops.

Also, the unit prices for the printing charges may differ by shops.

In this case, the calculation unit 420 (FIG. 3) is required to calculate the printing charges based upon the unit prices that differ by shops.

When the upper-limit amount of money and the unit prices are different by shops in this manner, the database unit 450 (FIG. 3) stores the upper-limit amount and the unit prices by shops.

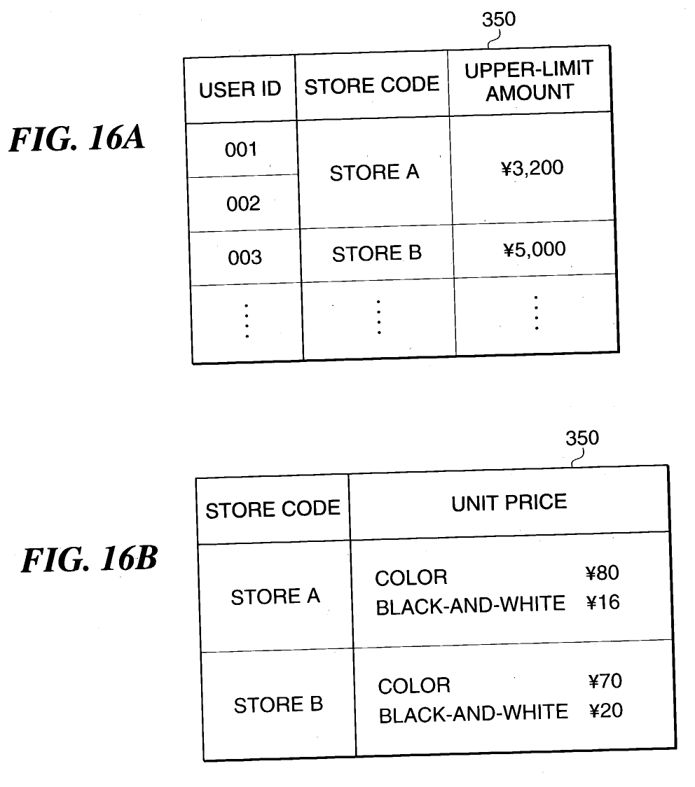

FIG. 16A illustrates a table in which the database unit 450 (FIG. 3) stores the shop codes and the upper-limit amounts of money in association with the users, and FIG. 16B illustrates a table in which the database unit 450 stores the unit prices of the printing charges.

As shown in FIG. 16A, the database unit 450 stores the shop codes (shop A and shop B) and the upper-limit amounts of money (¥3,200 and ¥5,000), in association with the user IDs to identify the users.

The available shops (shops having the printer 50 installed) are predetermined to the users each, which are associated with the user IDs.

The upper-limit amounts of money are set in accordance with the upper limits that the payment accepting unit 56 of the printer 50 used by the users allows the users to input.

As shown in FIG. 16B, the database unit 450 (FIG. 3) stores the unit prices for color printing and the unit prices for black-and-white printing by the shop codes each.

The calculation unit 420 (FIG. 3) calculates the charges for printing the data file with reference to the unit prices stored in the database unit 450.

It is preferable to store the user IDs, the shops, the upper-limit amounts of money, and the unit prices in a state that these data are associated with each other when the upper-limit amounts and the unit prices are different by the shops each.

According to the printing apparatus of the present invention and the printing method of the same, it is possible to display the printing format that the user is able to specify, in accordance with the attributes of the data files acquired from external devices.

The entire disclosure of Japanese Patent Application No. 2002-238332 filed on Aug. 19, 2002 including specification, claims, drawings and abstract is incorporated herein by reference in its entirety.

What is claimed is:

1. A printing apparatus that prints data files stored in an external device, comprising:
specifying means for allowing a user to specify at least one data file among the stored data files; and
display means for displaying a selectable printing format of the specified data file in accordance with an attribute of the specified data file.

2. The printing apparatus according to claim 1, wherein the attribute of the data file is given when the data file is stored in the external device; and
the display means displays the selectable printing format in accordance with the attribute given to the data file.

3. The printing apparatus according to claim 1, wherein
the attribute of the data file at least shows whether or not to allow for color printing; and
the display means displays color printing and black-and-white printing as the selectable printing format when the attribute of the data file allows for color printing.

4. The printing apparatus according to claim 3, further comprising printing charge information acquisition means for acquiring printing charge information from the external device to specify a printing charge for printing the data file, wherein
the display means further displays the printing charge specified by the printing charge information.

5. The printing apparatus according to claim 4, wherein
the printing charge information acquisition means acquires printing charge information to specify a printing charge for printing in color and a printing charge for printing in black-and-white when the attribute of the data file allows for color printing.

6. A printing system comprising: a data file providing apparatus that provides a data file, and a printer that prints the provided data files, wherein
the data file providing apparatus includes sending means for sending the data file and a printing format specifying information for specifying a selectable printing format when the data file is to be printed; and
the printing apparatus includes file acquisition means for acquiring the sent data file, and display means for displaying the printing format specified by the printing format specifying information.

7. A printing method for printing data files stored in an external device, comprising the steps of:
specifying one or more data files among the data files; and
displaying a selectable printing format when the data file is to be printed in accordance with an attribute of the data file specified.

8. A storage medium readable by a computer, the storage medium storing a program of instructions executable by the computer to perform a function for printing data files stored in an external device, the function comprising the steps of:
specifying at least one data file among data files stored in an external device; and
displaying a selectable printing format when the specified data file is to be printed in accordance with an attribute of the specified data file.
